(19) United States
(12) Patent Application Publication
(10) Pub. No.: US 2026/0077855 A1
(43) Pub. Date: Mar. 19, 2026

(54) AIRCRAFT HAVING A PROPULSION SYSTEM

(71) Applicant: General Electric Company, Evendale, OH (US)

(72) Inventors: Arthur William Sibbach, Boxford, MA (US); Robert Eugene Dyson, Loveland, OH (US); Jeffrey Donald Clements, Mason, OH (US); Jeffrey Douglas Rambo, Mason, OH (US); Daniel Alan Niergarth, Norwood, OH (US); Brandon Wayne Miller, Middletown, OH (US)

(21) Appl. No.: 18/888,961

(22) Filed: Sep. 18, 2024

(51) Int. Cl. B64C 15/02; B64C 39/10

(52) U.S. Cl. CPC B64C 15/02; B64C 39/10; B64C 2039/105

(57) ABSTRACT

An aircraft is provided defining a longitudinal direction, a lateral direction, and a longitudinal centerline extending along the longitudinal direction, the aircraft including: a body; a pair of wings extending outward from the body along the lateral direction, each wing of the pair of wings defining a leading edge; and a propulsion system comprising a first engine and a second engine spaced from one another along the lateral direction, the propulsion system further comprising a first thrust vectoring system operable with the first engine and a second thrust vectoring system operable with the second engine.

### FIELD

The present disclosure relates to an aircraft that includes a propulsion system and methods for operating the same.

### BACKGROUND

As is generally understood, aircraft typically include various different control surfaces, including rudders, elevators, ailerons, flaps, slats, etc. Conventionally, these control surfaces have been placed at certain locations on the aircraft, such as on the wings or on the tail of the aircraft. However, as aircraft designs progress and change over time, the design of control surfaces must similarly be assessed to accommodate differing aircraft configurations while maintaining aerodynamic efficiency and suitable flight control. Accordingly, improvements in aircraft control would be welcomed in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a top, schematic view of an aircraft in accordance with an exemplary aspect of the present disclosure.

FIG. 2 is a schematic, cross-sectional view of a first engine of a propulsion system of the aircraft of FIG. 1 in accordance with an exemplary embodiment of the present disclosure.

FIG. 3 is a perspective view of a first thrust vectoring system of the propulsion system of the aircraft of FIG. 1 in accordance with an exemplary embodiment of the present disclosure.

FIG. 4 is a side, schematic view of a slat assembly of the first thrust vectoring system of FIG. 3 in accordance with an exemplary embodiment of the present disclosure.

FIG. 5 is a schematic view of the first thrust vectoring system of FIG. 3, as viewed along an axial direction, as is indicated by Line 5-5 in FIG. 4.

FIG. 6 is a top, schematic view of the exemplary aircraft of FIG. 1 depicting a first thrust vectoring arrangement in accordance with an exemplary aspect of the present disclosure.

FIG. 7 is a top, schematic view of the exemplary aircraft of FIG. 1 depicting a second thrust vectoring arrangement in accordance with an exemplary aspect of the present disclosure.

FIG. 8 is a top, schematic view of the exemplary aircraft of FIG. 1 depicting a third thrust vectoring arrangement in accordance with an exemplary aspect of the present disclosure.

FIG. 9 is a schematic, cross-sectional view of a first engine in accordance with another exemplary embodiment of the present disclosure.

FIG. 10 is a top, schematic view of a first engine and first thrust vectoring system in accordance with an exemplary embodiment of the present disclosure.

FIG. 11 is a side, schematic view of a first engine and first thrust vectoring system in accordance with another exemplary embodiment of the present disclosure.

FIG. 12 is a top, schematic view of a first engine and first thrust vectoring system in accordance with yet another exemplary embodiment of the present disclosure.

FIG. 13 is a top, schematic view of a first engine and first thrust vectoring system in accordance with still another exemplary embodiment of the present disclosure.

FIG. 14 is a top, schematic view of a first engine and first thrust vectoring system in accordance with yet another exemplary embodiment of the present disclosure.

FIG. 15 is a top, schematic view of a first engine and first thrust vectoring system in accordance with still another exemplary embodiment of the present disclosure.

FIG. 16 is a flow diagram of a method of operating an aircraft in accordance with an exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The singular forms “a”, “an”, and “the” include plural references unless the context clearly dictates otherwise.

The term “at least one of” in the context of, e.g., “at least one of A, B, and C”refers to only A, only B, only C, or any combination of A, B, and C.

The phrases “from X to Y” and “between X and Y” each refers to a range of values inclusive of the endpoints (i.e., refers to a range of values that includes both X and Y).

The term “turbomachine” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The term “combustion section” refers to any heat addition system for a turbomachine. For example, the term combustion section may refer to a section including one or more of a deflagrative combustion assembly, a rotating detonation combustion assembly, a pulse detonation combustion assembly, or other appropriate heat addition assembly. In certain example embodiments, the combustion section may include an annular combustor, a can combustor, a cannular combustor, a trapped vortex combustor (TVC), or other appropriate combustion system, or combinations thereof.

The terms “forward” and “aft” refer to relative positions within a gas turbine engine or vehicle, and are based on a normal operational attitude of the gas turbine engine or vehicle. More particularly, forward and aft are used herein are with reference to a direction of travel and a direction of propulsive thrust of the gas turbine engine or vehicle.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

As used herein, the terms “first”, “second”, and “third” may be used interchangeably to distinguish one component from another and are not intended to signify location or importance of the individual components.

As noted above, improvements in aircraft control would be welcomed in the art. Moreover, it will be appreciated that improvements to traditional aircraft design to allow for increased efficiency and cargo utilization would be welcomed in the art. The inventors of the present disclosure found that utilization of a blended wing aircraft design can provide such an improvement. In particular, with the blended wing aircraft design, a body of the aircraft can contribute to lift, while also allowing for increased cargo space, improved aerodynamic efficiency, etc.

However, blended wing aircraft may have a reduced maneuverability given the large size of a body compared to a size of the wings. Accordingly, in order to provide an increased degree of maneuverability, while still providing gains in aircraft aerodynamic efficiency, cargo space, etc., the inventors found that a propulsion system may be provided with thrust vectoring capabilities. In particular, the propulsion system may include at least a first engine and a second engine spaced from one another along a lateral direction of the aircraft, as well as a first thrust vectoring system operable with the first engine and a second thrust vectoring system operable with the second engine.

Incorporation of the first and second thrust vectoring systems with the propulsion system may allow for a reduction in size of one or more control surfaces. Additionally, the first and second thrust vectoring systems further may allow for adjustment for yaw in the event of unbalanced thrust due to an engine failure, allowing the engines to be spaced farther apart along the lateral direction, improving overall aerodynamic efficiency of the aircraft. Moreover, the first and second thrust vectoring systems may allow the aircraft to spoil thrust by directing nozzles towards or away from each other to minimize ground idle thrust and brake wear of the aircraft.

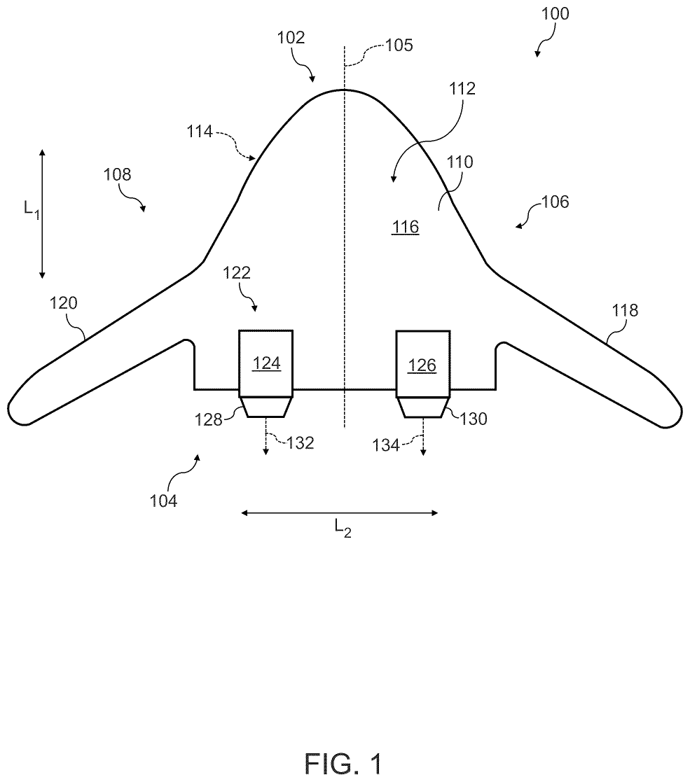

Referring now to the drawings, wherein identical numerals indicate the same elements throughout the figures, FIG. 1 provides a top view of an aircraft 100 as may incorporate various embodiments of the present disclosure. In particular, as will be discussed in greater detail, below, the aircraft 100 of FIG. 1 is configured as a blended wing aircraft.

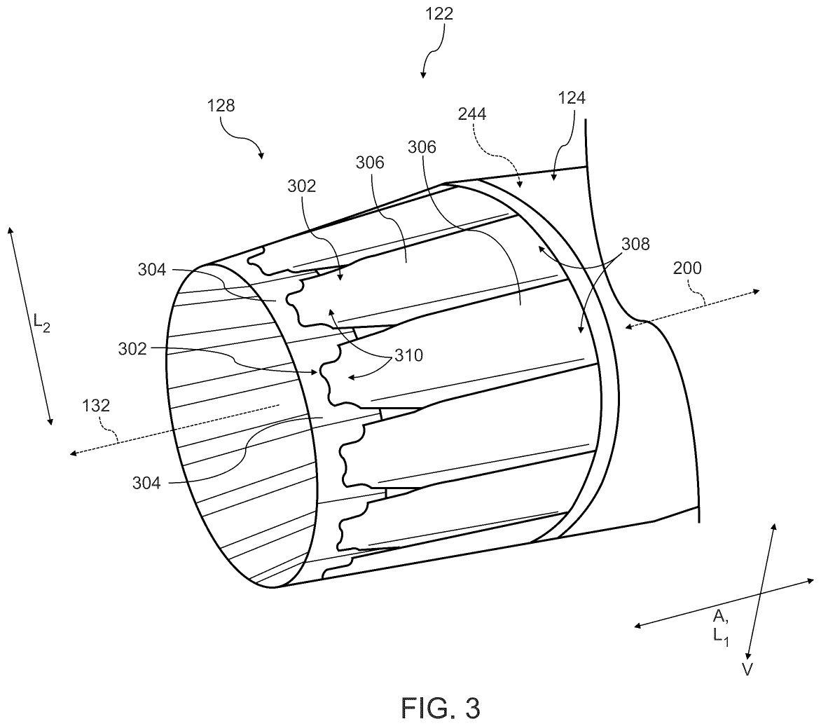

The aircraft 100 defines a longitudinal direction L₁ that extends therethrough, a lateral direction L₂, a vertical direction V (see, e.g., FIG. 3, below), a forward end 102 and an opposing aft end 16 along the longitudinal direction L₁, a longitudinal centerline 105 along the longitudinal direction L₁, a starboard side 106 and an opposing port side 108 along the lateral direction L₂, and a top side 112 and an opposing bottom side 114 (indicated by a phantom lead line) along the vertical direction V.

Further, it will be appreciated that the aircraft 100 includes a body 110 extending longitudinally from the forward end 102 of the aircraft 100 to the aft end 104 of the aircraft 100, and a pair of wings. In particular, the aircraft 100 includes a first wing 118 and a second wing 120. The first wing 118 extends outwardly from the body 110 generally along the lateral direction L₂ on the starboard side 106 and the second wing 120 similarly extends outwardly from the body 110 generally along the lateral direction L₂ on the port side 108. Although not depicted, it will be appreciated that each of the wings 118, 120 may include one or more leading edge flaps, one or more trailing edge flaps, or both.

The exemplary aircraft 100 of FIG. 1 also includes a propulsion system 122. The exemplary propulsion system 122 depicted includes a plurality of engines, and more specifically includes a first engine 124 and a second engine 126. In the embodiment depicted, the first engine 124 and the second engine 126 are spaced from one another along the lateral direction L₂, and are mounted to the body 110 of the aircraft 100 at the aft end 104 of the aircraft 100. It will be appreciated, that as used herein, the term “at the aft end 104” refers to a location along the longitudinal direction L₁ closer to the aft end 104 of the aircraft 100 than the forward end 102 of the aircraft 100. Briefly, it will further be appreciated that for the embodiment depicted, the first engine 124 and second engine 126 are mounted to the body 110 of the aircraft 100 on the top side 112 of the aircraft 100.

It will be appreciated, however, that in other exemplary embodiments, the first engine 124 and second engine 126 may be mounted to the body 110, e.g., on a bottom side 114 or at a trailing edge (not labeled). Further, the although the first engine 124 and second engine 126 are coupled to the body 110 in the embodiment shown, in other embodiments, they may be formed integrally with the body 110.

As noted above, the aircraft 100 is configured as a blended wing aircraft. In such a manner, it will be appreciated that the body 110 of the aircraft 100 is generally shaped like an airfoil, such that the body 110 of the aircraft 100 generates upward lift (along the vertical direction V) during steady altitude flight operations. For example, during a cruise operating condition of the aircraft 100, the body 110 may contribute between 10% and 95% of the upward lift for the aircraft 100, such as between 25% and 90% of the upward lift for the aircraft 100, with the remainder being provided by the first and second wings 118, 120. In addition, the first and second wings 118, 120 are aerodynamically contoured to have a smooth transition with the body 110 of the aircraft 100, which can reduce an overall drag on the aircraft 100.

Referring still to FIG. 1, it will be appreciated that the propulsion system 122 further includes a first thrust vectoring system 128 operable with the first engine 124 and a second thrust vectoring system 130 operable with the second engine 126. In particular, the aircraft 100 of FIG. 1 defines a horizontal plane (i.e., the plane depicted in FIG. 1) extending in the lateral direction L₂ and in the longitudinal direction L₁. The first thrust vectoring system 128 is operable with the first engine 124 to adjust a first thrust vector 132 from the first engine 124 in the horizontal plane, and the second thrust vectoring system 130 is operable with the second engine 126 to adjust a second thrust vector 134 from the second engine 126 in the horizontal plane.

As will be appreciated from the description hereinbelow, the first and second thrust vectoring systems 128, 130 may additionally or alternatively be configured to adjust the first and second thrust vectors 132, 134 in angles relative to the horizontal plane (e.g., in directions out of the horizontal plane/in a vertical plane defined by the longitudinal direction L₁ and vertical direction V).

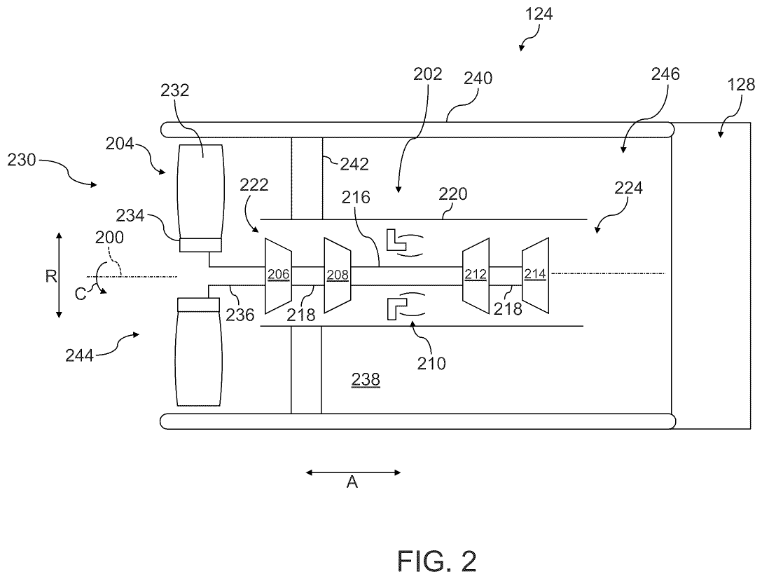

Referring now to FIG. 2, a schematic cross-sectional view of the first engine 124 of the propulsion system 122 of an aircraft 100 of FIG. 1 is presented, depicting an exemplary incorporation of the first thrust vectoring system 128.

It will be appreciated that although the first engine 124 and first thrust vectoring system 128 are depicted and discussed, the second engine 126 and second thrust vectoring system 130 may be configured in a similar manner as one or more of these embodiments.

The first engine 124 is configured as a gas turbine engine. For example, the first engine 124 includes a turbomachine 202 and a fan assembly 204, and defines an axial direction A, a radial direction R, and a circumferential direction C. The fan assembly 204 includes a fan 230 positioned proximate a forward end of the first engine 124.

The turbomachine 202 of the gas turbine engine defines a turbomachine inlet 222 and a turbomachine exhaust 224, and includes a compressor section, a combustion section 210, and a turbine section. The compressor section includes a low-pressure compressor 206 and a high-pressure compressor 208. The combustion section 210 receives compressed air from the compressor section and mixes it with fuel for combustion, which generates high-energy exhaust gases. These exhaust gases then flow into the turbine section, which includes a high-pressure turbine 212 and a low-pressure turbine 214. The high-energy exhaust gases expand through the turbine section, causing the turbines to rotate and produce mechanical work. In particular, it will be appreciated that for the embodiment shown, the turbomachine 202 further includes a high pressure shaft 216 extending between and mechanically coupling the high-pressure compressor 208 and high pressure turbine 212, and a low pressure shaft 218 extending between and mechanically coupling the low pressure compressor 206 and low pressure turbine 214.

As noted, the fan assembly 204 includes the fan 230 and defines a fan inlet 244. The fan 230 in turn includes a plurality of fan blades 232 and a fan disk 234, with the plurality of fan blades 232 coupled to the fan disk 234. The fan assembly 204 further includes a fan shaft 236 mechanically coupling the turbomachine 202 with the fan 230 (via, e.g., one or more of the low pressure compressor 206 or low pressure shaft 218).

The gas turbine engine 124 further includes a nacelle 240 that encloses the fan 230 and defines in part the fan inlet 244, and further defines an engine exhaust 246 for the embodiment shown. The nacelle 240 surrounds the fan 230 and is coupled to the turbomachine 202 through a plurality of inlet guide vanes 242 located upstream of the fan blades 232 of the fan 230. In such a manner, it will be appreciated that the gas turbine engine of FIG. 2 is more specifically configured as a turbofan engine.

Notably, it will be appreciated that the gas turbine engine 124 depicted in FIG. 2 is a mixed flow engine, meaning that an airflow from the bypass passage 238 and an airflow from the turbomachine exhaust 224 are mixed together prior to flowing out of the engine exhaust 246. In particular, for the embodiment depicted, the nacelle 240 extends aft of the turbomachine exhaust 224 to provide such functionality.

Moreover, the nacelle 240 surrounds the turbomachine 202 and defines a bypass passage 238 with an outer casing 220 of the turbomachine 202.

The first thrust vectoring system 128 is operable with the first engine 124, in the embodiment depicted, by being coupled to an aft end of the first engine 124, downstream of the engine exhaust 246. More specifically, the first thrust vectoring system 128 is coupled to the nacelle 240, such that at least all of the airflow from the turbomachine exhaust 224 flows into and through the first thrust vectoring system 128, and more specifically for the embodiment of FIG. 2, such that all airflow from the first engine 124 flows into and through the first thrust vectoring system 128.

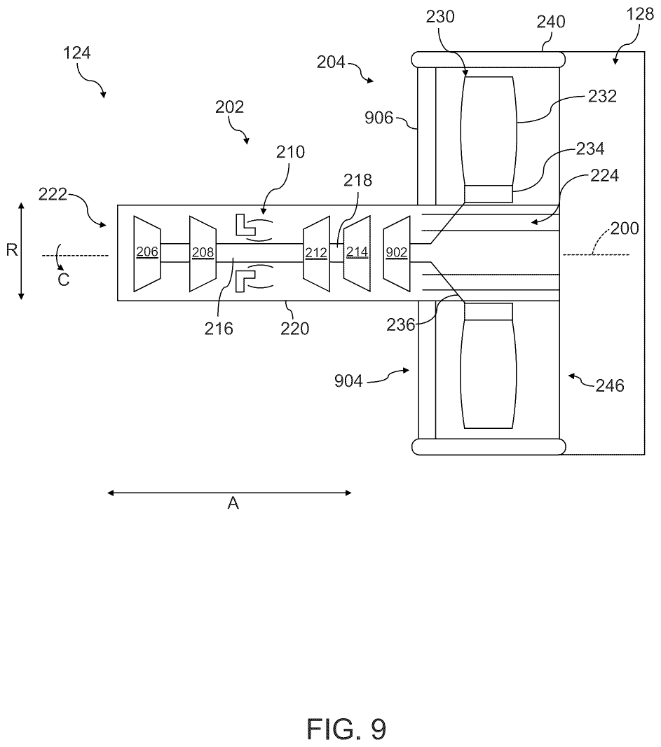

The first engine 124 depicted in FIG. 2 is an example of one exemplary embodiment of an engine that may be utilized with one or more aspects of the present disclosure. However, it should be understood that the present disclosure is not limited to this specific configuration and can include other types of gas turbine engines, such as open rotor engines, geared gas turbine engines, variable pitch gas turbine engine engines, engines arranged in a pusher configuration (see, e.g., FIG. 9), etc.

Referring now to FIG. 3, a perspective view of a first thrust vectoring system 128 of a propulsion system 122 of an aircraft 100 in accordance with an exemplary aspect of the present disclosure is depicted. The first thrust vectoring system 128 is shown in conjunction with a first engine 124 of the propulsion system 122 to illustrate the integration and functionality of the first thrust vectoring system 128 within the propulsion architecture of the aircraft 100.

The first thrust vectoring system 128 is a variable nozzle located at the engine exhaust 246 or downstream of the engine exhaust 246. More specifically, the first thrust vectoring system 128 includes a plurality of slat assemblies 302, each including an inner slat 304 and an outer slat 306. These slat assemblies 302 are arranged circumferentially around an aft portion of the first engine 124, near an engine exhaust 246 of the first engine 124 (see FIG. 2), to form the complete first thrust vectoring system 128. More specifically, it will be appreciated that the first engine 124 defines an axial direction A and a circumferential direction C (not labeled, a direction extending about the axial direction A). The plurality of slat assemblies 302 (each including inner and outer slats 304, 306) of the first thrust vectoring system 128 are arranged along the circumferential direction C.

Each outer slat 306 extends from an upstream end 308 to a downstream end 310. The upstream end 308 of each outer slat 306 is pivotally connected to the engine 124 and the downstream end 310 is slidably connected to the inner slat 304. The inner slats 304 are situated inward of the outer slats 306 and are moveable by the outer slat 306 to adjust the first thrust vector 132.

The slat assemblies 302 are designed to be responsive to the control inputs from the aircraft's control system, which can command adjustments in the thrust vectoring to achieve desired changes in, e.g., the aircraft's attitude and direction. For example, the slat assemblies 302 can be actuated to direct thrust upwards, downwards, port side, starboard side, or any combination thereof, in response to the aircraft's control requirements. This multi-directional thrust vectoring capability is particularly advantageous in a blended wing body (BWB) aircraft, where traditional control surfaces may be minimized or absent.

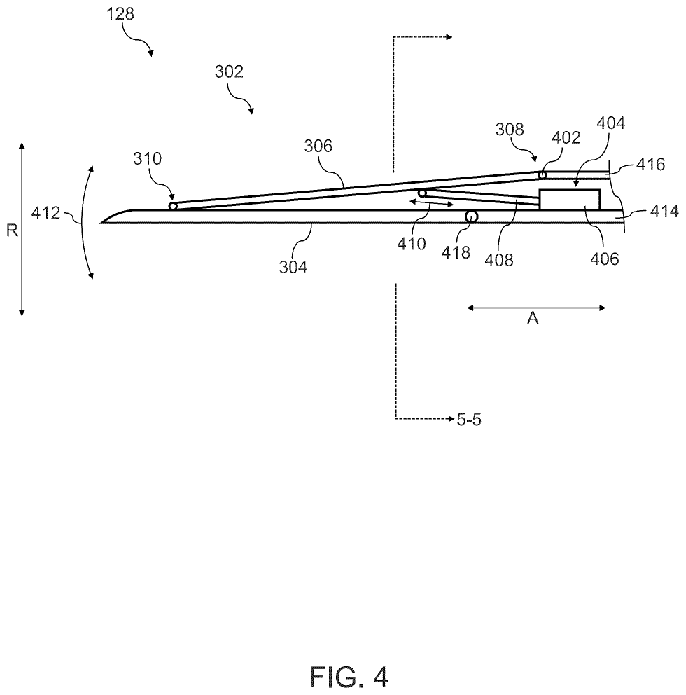

In particular, referring now to FIG. 4, a side schematic view of a slat assembly 302 of the plurality of slat assemblies 302 of the first thrust vectoring system 128 of FIG. 3 is depicted. As noted above, the slat assembly 302 includes the inner slat 304 and the outer slat 306. The outer slat 306 extends longitudinally from the upstream end 308 to the downstream end 310. At the upstream end 308, the outer slat 306 is pivotably coupled to an outer structural member 416 of the first engine 124, defining a pivot point 402 with the outer structural member 416.

The first thrust vectoring system 128 further includes an actuator 404 operably coupled to the outer slat 306. The actuator 404 includes a motor 406 and an extension member 408, which can extend or retract along an extension direction 410. The extension member is pivotably coupled to the outer slat 306, such that movement of the extension member 408 by the motor 406 along the extension direction 410 causes the outer slat 306 to pivot about the pivot point 402.

The inner slat 304 is pivotably coupled to an inner structural member 414 of the first engine 124, defining a pivot point 418 with the inner structural member 414. The inner and outer structural members 414, 416 may be a common structure of the first engine 124 or separate structures. The outer slat 306 is slidably coupled to the inner slat 304 at the downstream end 310 of the outer slat 306, such that movement of the outer slat 306 (about the pivot point 402) by the actuator 404 causes the inner slat 304 to pivot about pivot point 418, further causing the slat assembly 302 to move in a pivot direction 412.

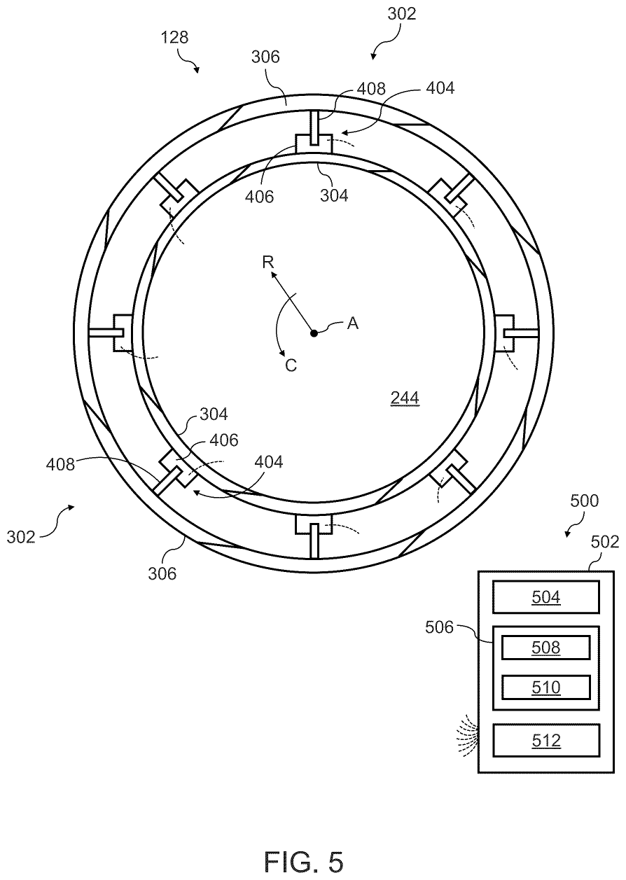

Referring now to FIG. 5, a schematic view of the first thrust vectoring system 128 of FIG. 4 is shown, as viewed along the axial direction A, as indicated by Line 5-5 in FIG. 4. This view illustrates the circumferential arrangement of the slat assemblies 302 in additional detail.

Moreover, it will be appreciated from the view of FIG. 5, that the actuator 404 depicted above with reference to FIG. 4 is a first actuator 404 of the first thrust vectoring system 128, and the first thrust vectoring system 128 further includes a plurality of actuators 404 spaced along the circumferential direction C. Each actuator 404 is operably coupled to at least one slat of the plurality of slats and less than all of the slats of the plurality of slats, and more specifically is operably coupled to at least one slat assembly 302 of the plurality of slat assemblies 302 and less than all of the slat assemblies 302 of the plurality of slat assemblies 302. In particular, the plurality of slats/slat assemblies 302 includes N number of slats/slat assemblies 302, and the plurality of actuators 404 includes at least three actuators 404 and up to N number of actuators 404.

The plurality of actuators 404 facilitate redirecting air in a horizontal plane, defined by the longitudinal direction L₁ and the lateral direction L₂ (see FIG. 1), as well as within a vertical plane, defined by the longitudinal direction L₁ and the vertical direction V (see FIG. 3). The plurality of actuators 404 are operably independent of one another to provide such functionality.

More specifically, the first thrust vectoring system 128 includes the plurality of slat assemblies 302 arranged circumferentially around the engine exhaust 246. Each slat assembly 302 includes the inner slat 304 and the outer slat 306. The inner slat 304 and the outer slat 306 are configured to pivot about their respective pivot points (see FIG. 4), to direct the airflow from the first engine 124 in different directions. The first thrust vectoring system 128 includes the plurality of actuators 404, each including a respective motor 406 and extension member 408, operably coupled to a respective one of the plurality of slat assemblies 302. These actuators 404 are spaced along the circumferential direction C and are capable of operating independently to provide precise control over the direction of the thrust vectoring.

It will be appreciated, however, that the arrangement of the slat assemblies 302 and actuators 404 in FIG. 5 is exemplary and not limiting. Alternative embodiments can include different numbers and configurations of slat assemblies and actuators, as well as variations in the control systems used to operate them. The present disclosure contemplates the use of different types of actuators, including but not limited to hydraulic, pneumatic, or electric actuators, to suit various design requirements and operational needs.

Moreover, in other exemplary embodiments, the first thrust vectoring system 128 may include any other suitable variable nozzle geometry. For example, in other embodiments, the variable nozzle may have a constant throat area, utilizing a bearing swivel design to change the first thrust vector 132. For example, the variable nozzle may utilize a three bearing swivel design. Other arrangements may be provided as well.

Referring still to FIG. 5, the propulsion system 122 further includes a controller 500. The controller 500, which can be one or more computing devices 502, is equipped with one or more processors 504 and a memory 506. The memory 506 stores data 508 and instructions 510 that, when executed by the processor 504, facilitate the control of the actuators 404. The controller 500 also includes a network communications module 512, which allows for communication with the actuators 404 and potentially other systems within the aircraft.

The controller 500 may be operably coupled to the first and second engines 124, 126 and the first and second thrust vectoring system 128, 130 (see, also, FIG. 1). In operation, the controller 500 receives data indicative of an aircraft operating condition and provides command data to the first and second thrust vectoring system 128, 130 (e.g., to the actuators 404) in response to the received data, e.g., to adjust the respective thrust vectors 132, 134 accordingly. The data provided to the controller 500 can include information such as aircraft speed, altitude, attitude, desired direction changes, engine performance parameters or operating conditions (e.g., temperatures, pressures, fuel flows, etc.), and other relevant flight data or operating condition data. Based on this input, the controller 500 generates command signals that are transmitted to the first and second thrust vectoring system 128, 130, which for the embodiment discussed hereinabove, adjusts the positions of the slats 304, 306 to alter the direction of the exhaust flow and thus the thrust vectors 132, 134.

In such a manner, it will be appreciated that the second thrust vectoring system 130 may be configured in a similar manner as the first thrust vectoring system 128. The controller 500 can be operably coupled to both the first and second thrust vectoring systems 128, 130, and can be configured to control the first and second thrust vectoring systems 128, 130 independently.

The first and second thrust vectoring systems 128, 130 offer a practical application for maneuvering the aircraft during various phases of flight/aircraft operating conditions, such as idle, takeoff, cruise, and landing, as well as for maintaining control in the event of an engine failure. The ability to independently control the direction of the thrust vectors allows for enhanced aircraft performance and safety, particularly in a blended wing body aircraft configuration where traditional control surfaces may be minimized.

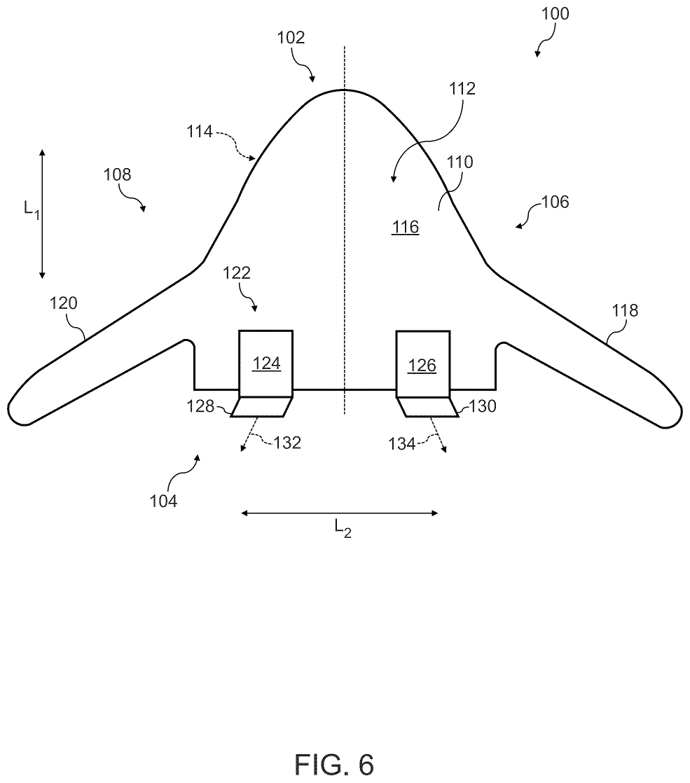

Referring now to FIGS. 6 through 8, top schematic views of an aircraft 100 in accordance with the present disclosure are provided, depicting various operating conditions of the aircraft 100 and its propulsion system 122. The aircraft 100 and propulsion system 122 of FIGS. 6 through 8 may be configured in a similar manner as the exemplary aircraft 100 and propulsion system 122 of FIGS. 1 through 5, discussed above, and the same or similar numbers may refer to the same or similar parts.

For example, the propulsion system 122 of the aircraft 100 includes a first engine 124 and a second engine 126. These engines are spaced from one another along the lateral direction L₂, which may allow for the distribution of propulsive flow over a larger portion of a lifting surface of the aircraft 100, which maximizes propulsive efficiency. Each engine 124, 126 is operatively associated with a respective first thrust vectoring system 128 and second thrust vectoring system 130. These thrust vectoring systems 128, 130 are capable of adjusting a first thrust vector 132 and a second thrust vector 134, respectively, to, e.g., enhance the maneuverability and control of the aircraft 100.

In the embodiment shown in FIG. 6, the first and second thrust vectoring systems 128, 130 are depicted as directing the respective first thrust vector 132 and second thrust vector 134 away from one another. This thrust vectoring arrangement is particularly advantageous during ground operations, such as taxiing, where it is desirable to minimize ground idle thrust and consequently reduce wear on the aircraft's brakes. The aircraft 100 can be considered to be in an idle operating condition during these operations. By directing the thrust vectors away from each other, the aircraft 100 can effectively ‘spoil’ the thrust without relying excessively on a brake system of the aircraft, leading to a reduction in brake wear and an increase in the overall efficiency of ground operations.

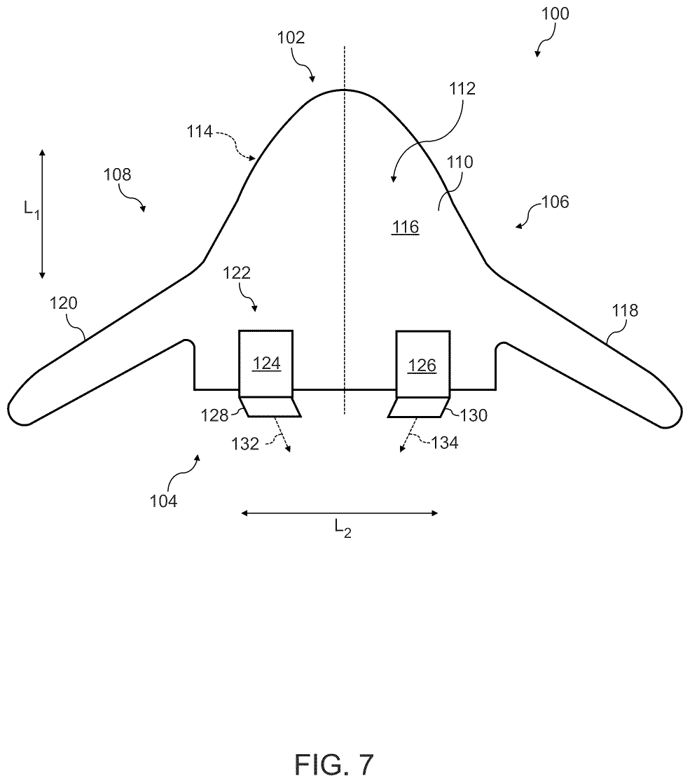

Referring now to FIG. 7, the first and second thrust vectoring systems 128, 130 are configured to direct the respective first thrust vector 132 and second thrust vector 134 towards each other. This configuration may also be particularly advantageous during ground operations (e.g., idle operating condition of the aircraft 100). This thrust vectoring arrangement similarly serves to minimize ground idle thrust and consequently reduce wear on the aircraft's brakes. By orienting the thrust vectors towards one another, the aircraft 100 can effectively ‘spoil’ the thrust, decreasing reliance on the braking system and enhancing the efficiency of ground operations.

Notably, as applied to the embodiment of FIG. 5, in the views of FIGS. 6 and 7, the aircraft operating condition is an idle operating condition in this state, and command data from the controller is to adjust the first thrust vector 132 from the first engine 124 and the second thrust vector 134 from the second engine 126 to spoil thrust from the first and second engines 124, 126.

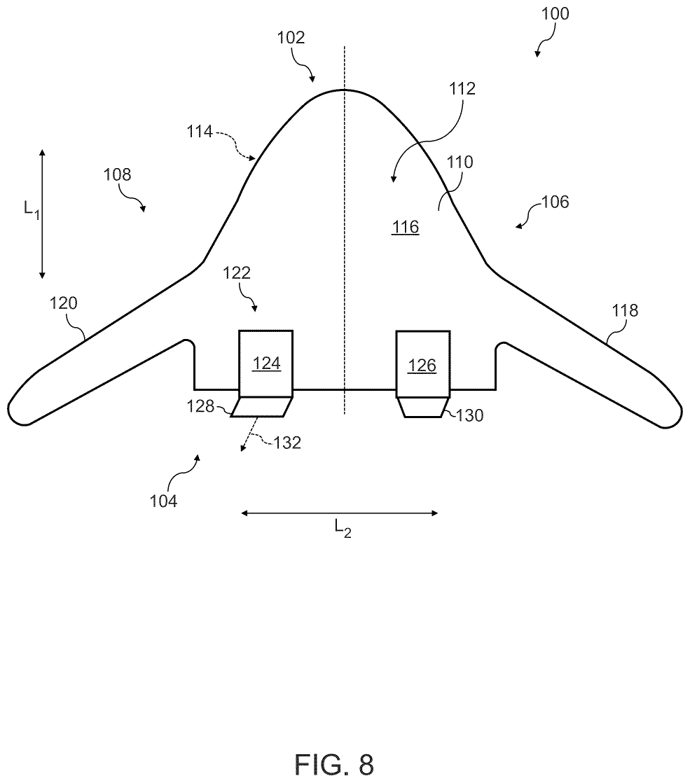

Referring now to FIG. 8, a flight operation of the aircraft 100 is shown where one of the engines has experienced a failure. In particular, in the scenario depicted in FIG. 8, the aircraft 100 is shown with the first thrust vectoring system 128 actively adjusting the first thrust vector 132 of the first engine 124. This adjustment is in response to receiving data indicative of a failure condition of the second engine 126 (e.g., by a controller), which is no longer contributing to the thrust of the aircraft 100. In response, the controller can provide command data to the first thrust vectoring system 128 to adjust a first thrust vector 132 from the first engine 124 away from the longitudinal centerline of the aircraft 100.

The ability to adjust the first thrust vector 132 in such a manner can enhance the safety and control of the aircraft 100 during an engine failure situation. For example, by vectoring the thrust of the operational engine 124, the aircraft 100 can maintain a more balanced flight and mitigate the adverse effects that would otherwise result from the loss of thrust on one side.

The thrust vectoring capability provided by the first thrust vectoring system 128 allows the aircraft 100 to compensate for the unbalanced thrust condition caused by the failure of the second engine 126. This is achieved by directing the first thrust vector 132 in such a way that it helps to counteract the yawing moment that would arise from the asymmetry in thrust. The first thrust vectoring system 128 can be controlled manually by the pilot or automatically through the aircraft's control system, which would process data related to the engine failure and command the necessary adjustments to the thrust vectoring system 128.

Notably, in other embodiments, a controller of the aircraft 100 (e.g., controller 500) may receive data indicative of the operating condition being a course change condition. In response to receiving the data, the controller 500 provide command data to the first thrust vectoring system 128 and the second thrust vectoring system 130 to adjust the first thrust vector 132 from the first engine 124 and the second thrust vector 134 from the second engine 126, the command data being to adjust the first thrust vector 132 from the first engine 124 and the second thrust vector 136 from the second engine 126 to assist is effectuating the course change condition (e.g., both starboard, both port, both up, both down, or combinations thereof).

The present disclosure contemplates various embodiments and configurations for the thrust vectoring systems 128, 130. For example, alternative embodiments may include thrust vectoring systems that can adjust thrust vectors in both the horizontal and vertical planes, providing even greater control and maneuverability. Additionally, the thrust vectoring systems may be designed to operate in coordination with other aircraft systems, such as flight control surfaces, to provide an integrated approach to aircraft control.

Referring now to FIG. 9, a schematic cross-sectional view of a first engine 124 in accordance with another exemplary embodiment of the present disclosure is provided. The first engine 124 of FIG. 9 may be configured in substantially the same manner as the exemplary first engine 124 of FIG. 2, and, accordingly, the same or similar numbers may refer to the same or similar parts.

For example, the first engine 124 defines an axial direction A, a radial direction R, and a circumferential direction C, and includes a turbomachine 202 and a fan assembly 204. The turbomachine 202 includes a low-pressure compressor 206, a high-pressure compressor 208, a combustion section 210, a high-pressure turbine 212, and a low-pressure turbine 214.

However, for the embodiment depicted, the first engine 124 is arranged in a “pusher” configuration, such that the fan assembly 204 is positioned proximate to the aft end of the first engine 124. The fan assembly 204 includes a fan 230 that features a plurality of fan blades 232 attached to a fan disk 234. The fan 230 is driven by a fan shaft 236, which is mechanically coupled to the turbomachine 202. In particular, for the embodiment depicted, the turbomachine 202 further includes a dedicated drive turbine 902 to power the fan assembly 204, driving the fan 230 across the fan shaft 236.

In such a manner, during operation the fan 230 may draw air through a fan inlet 904 and expel it through a fan exhaust 246. The fan assembly 204 further includes inlet guide vanes 906, which are situated upstream of the fan blades 232 to direct the airflow into the fan assembly 204 efficiently.

The propulsion system further includes a first thrust vectoring system 128 operably coupled to the first engine 124. The present disclosure contemplates various embodiments and configurations for integrating the thrust vectoring system with different engine types and arrangements. The materials and technologies used for the construction and operation of the thrust vectoring system can be selected based on factors such as performance, durability, and weight considerations, ensuring the adaptability and effectiveness of the present disclosure's propulsion system across a wide range of aircraft applications.

In certain embodiments, the first thrust vectoring system 128 of FIG. 9 may be configured to operate in a similar manner as the exemplary first thrust vectoring system 128 discussed above with reference to FIGS. 3 through 5. Alternatively, however, in other embodiments, other suitable configurations may be provided.

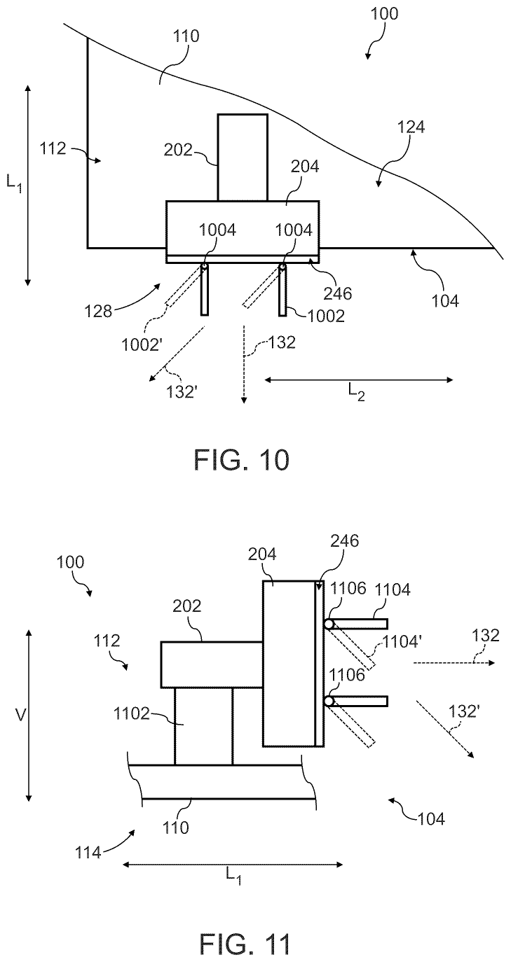

For example, referring now to FIG. 10, a top schematic view of a first engine 124 and a first thrust vectoring system 128 of the present disclosure is depicted. The first engine 124 may be configured in a similar manner as the exemplary first engine 124 of FIG. 9.

The aircraft 100, as shown, includes a body 110 and defines a top side 112 and an aft end 104. The first engine 124 is depicted with a turbomachine 202 and a fan assembly 204. The first thrust vectoring system 128, operable with the first engine 124, is illustrated with a plurality of vertical airflow fins 1002 arranged to extend generally in the longitudinal direction L₁ and vertical direction V away from the engine 124, each defining a vertical pitch axis 1004, about which the vertical airflow fins 1002 are configured to pivot. This pivotal movement enables the vertical airflow fins 1002 to adjust the thrust vector 132 in the lateral direction L₂, within a horizontal plane (defined by the longitudinal and lateral directions L₁, L₂). In particular, the first thrust vectoring system 128, as depicted in FIG. 10, is capable of vectoring the thrust to provide the aircraft with enhanced maneuverability and control.

Notably, the vertical airflow fins 1002 are shown in a neutral position, directing the first thrust vector 132 in the longitudinal direction L₁. The vertical airflow fins 1002 are shown in phantom (as 1002′) with the resulting first thrust vector 132 in phantom (as 132′) defining an angle with the longitudinal direction L₁, oriented towards the port side of the aircraft 100. Alternatively, the vertical airflow fins 1002 may be moved to the starboard side.

The present disclosure contemplates various embodiments of the first thrust vectoring system 128, wherein the vertical airflow fins 1002 can be configured in different numbers, sizes, and arrangements to suit specific aircraft designs and operational requirements.

In operation, the first thrust vectoring system 128 is controlled by a control system of the aircraft 100, which sends command signals to actuators (not shown in FIG. 10) associated with the vertical airflow fins 1002. (This operation may be similar to the operations discussed above with respect to, e.g., FIGS. 5 through 8, utilizing the controller 500.) These actuators adjust the position of the vertical airflow fins 1002 to achieve the desired redirection of the first thrust vector 132. The adjustments can be made in real-time, responding to the pilot's inputs or automated flight control algorithms, to maintain the desired aircraft attitude and trajectory.

The thrust vectoring capabilities provided by the vertical airflow fins 1002 offer practical benefits in various flight conditions. For instance, the vertical airflow fins 1002 can provide subtle adjustments to the aircraft's attitude for optimal aerodynamic efficiency. Furthermore, the first thrust vectoring system 128 can assist in maintaining control and stability during asymmetric thrust situations, such as an engine failure on the opposite side of the aircraft.

Referring now to FIG. 11, a side schematic view of a first engine 124 and a first thrust vectoring system 128 in accordance with another exemplary embodiment of the present disclosure is illustrated. The first engine 124 may be configured in a similar manner as the exemplary first engine 124 of FIG. 9.

The aircraft 100, as shown, includes a body 110 and defines a top side 112 and an aft end 104. The first engine 124 is depicted with a turbomachine 202 and a fan assembly 204. The first thrust vectoring system 128, operable with the first engine 124, is illustrated with a plurality of horizontal airflow fins 1104 that extend laterally from the engine 124.

The horizontal airflow fins 1104 are shown in their neutral positions, aligned with the longitudinal direction L₁ of the aircraft 100. Each horizontal airflow fin 1104 defines a horizontal pitch axis 1106, allowing the fins 1104 to pivot about the respective axis 1106. The pivotal movement of the horizontal airflow fins 1104 can be actuated to adjust the first thrust vector 132 in a vertical plane, which includes the longitudinal direction L₁ and the vertical direction V. The ability to adjust the thrust vector 132 in this manner provides the aircraft 100 with enhanced control over its pitch, contributing to the overall maneuverability and stability during flight operations.

The first thrust vectoring system 128, as depicted, is designed to provide thrust vectoring in the vertical plane, which includes the longitudinal direction L₁ and the vertical direction V. The horizontal airflow fins 1104 can be actuated to direct the thrust vector in a downward direction relative to the vertical plane, as indicated by the horizontal airflow fins 1104 shown in phantom (as 1104′) and the first thrust vector 132 shown in phantom (as 132′) in FIG. 11. Additionally, or alternatively, the horizontal airflow fins 1104 can be actuated to direct the thrust vector in an upward direction relative to the vertical plane. This capability is particularly beneficial during takeoff and landing phases of flight, where adjustments to the pitch of the aircraft are frequently required.

The present disclosure contemplates various embodiments of the first thrust vectoring system 128, wherein the horizontal airflow fins 1104 can be configured in different numbers, sizes, and arrangements to suit specific aircraft designs and operational requirements. The materials and construction of the horizontal airflow fins 1104 can be selected based on factors such as weight, strength, and resistance to the high temperatures associated with the engine exhaust 246.

In operation, the first thrust vectoring system 128 is controlled by a control system of the aircraft 100, which sends command signals to actuators (not shown in FIG. 11) associated with the horizontal airflow fins 1104. These actuators adjust the position of the fins 1104 to achieve the desired redirection of the first thrust vector 132. The adjustments can be made in real-time, responding to the pilot's inputs or automated flight control algorithms, to maintain the desired aircraft attitude and trajectory. (This operation may be similar to the operations discussed above with respect to, e.g., FIGS. 5 through 8, utilizing the controller 500.) The thrust vectoring capabilities provided by the horizontal airflow fins 1104 offer practical benefits in various flight conditions. For instance, during takeoff, the thrust vectoring system 128 can be used to enhance lift, while during cruise, it can provide subtle adjustments to the aircraft's attitude for optimal aerodynamic efficiency. Furthermore, the first thrust vectoring system 128 can assist in maintaining control and stability during asymmetric thrust situations, such as an engine failure on the opposite side of the aircraft.

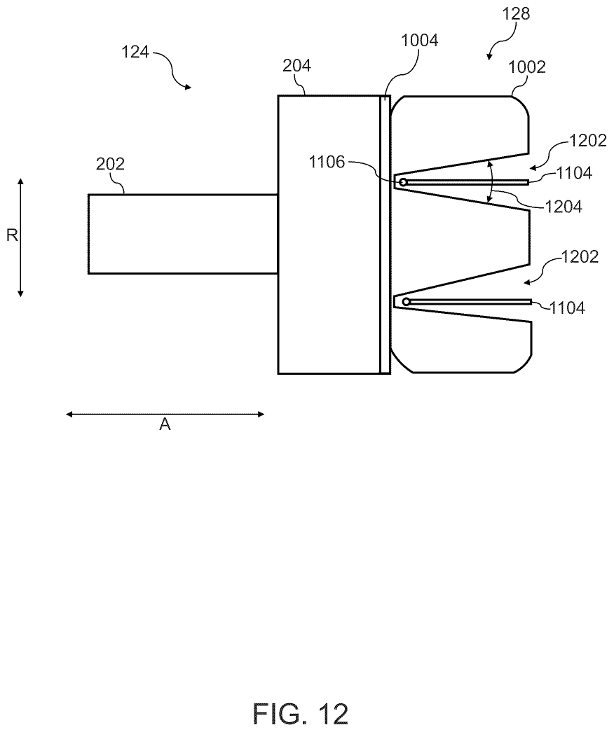

Referring now to FIG. 12, a top schematic view of a first engine 124 and a first thrust vectoring system 128 in accordance with yet another exemplary embodiment of the present disclosure is illustrated. The first engine 124 may be configured in a similar manner as the exemplary first engine 124 of FIG. 9.

The first engine 124 includes a turbomachine 202 and a fan assembly 204. The first thrust vectoring system 128, operable with the first engine 124, is depicted with a configuration that combines both vertical airflow fins 1002 (see FIG. 10) and horizontal airflow fins 1104 (see FIG. 11) to provide comprehensive thrust vectoring capabilities in both the horizontal plane and the vertical plane.

The vertical airflow fins 1002 may be configured in a similar manner as the exemplary vertical airflow fins 1002 of FIG. 10 and the horizontal airflow fins 1104 may be configured in a similar manner as the exemplary horizontal airflow fins 1104 of FIG. 11.

The first thrust vectoring system 128, as depicted in FIG. 12, is therefore capable of vectoring the thrust to adjust the thrust vector 132 in any desired direction, offering significant degree of freedom in terms of aircraft handling and response to pilot inputs or automated flight control systems.

As is depicted in FIG. 12, the vertical airflow fins 1002 include cutouts 1202, which accommodate the horizontal airflow fins 1104, ensuring that the fins do not interfere with each other during operation. The angular span 1204 of the cutouts 1202 is designed to provide sufficient clearance for the horizontal airflow fins 1104 to pivot without obstruction, allowing for seamless integration and functionality of the first thrust vectoring system 128.

The first thrust vectoring system 128, as shown in FIG. 12, represents an exemplary embodiment of the present disclosure, providing a clear illustration of the integration of both vertical and horizontal airflow fins 1002, 1104 to achieve a full range of thrust vectoring capabilities. This system enhances the aircraft's performance, particularly in a blended wing body (BWB) configuration, where traditional control surfaces may be minimized or absent, and where the ability to adjust thrust vectors in multiple planes is of paramount importance.

The present disclosure contemplates various embodiments and configurations for the first thrust vectoring system 128, allowing for customization and optimization based on specific aircraft designs and operational requirements. The materials and construction techniques employed for the vertical and horizontal airflow fins 1002, 1104 can be selected based on factors such as weight, strength, and thermal resistance, considering the high-temperature environment associated with the engine exhaust.

In operation, the first thrust vectoring system 128 can be actuated to direct the thrust in various directions, responding to the control inputs from the aircraft's control system. This capability is beneficial during all phases of flight, including takeoff, cruise, and landing, and is especially valuable in maintaining control and stability during asymmetric thrust situations, such as an engine failure. These operations may be similar to the operations discussed above with respect to, e.g., FIGS. 5 through 8, utilizing the controller 500.

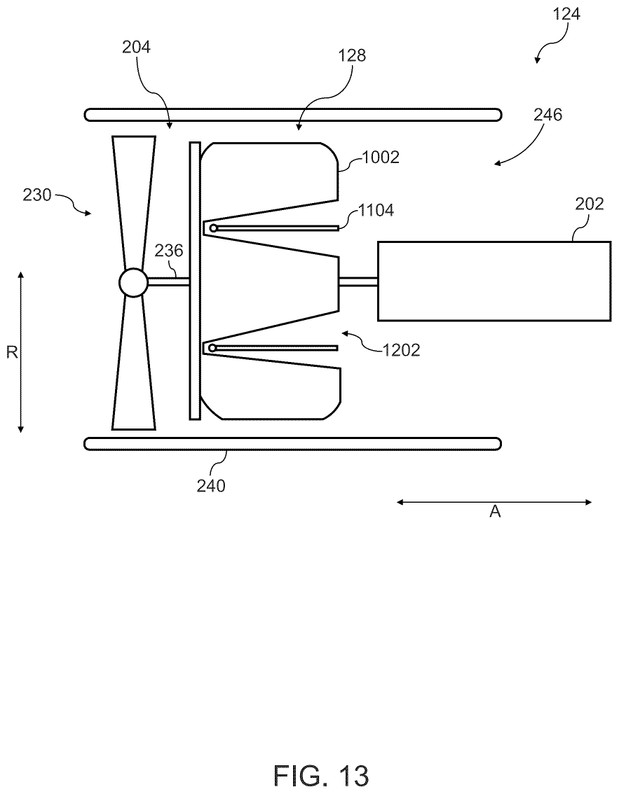

It will be appreciated, however, that although the exemplary first thrust vectoring system 128 described above are positioned at an aft end of the respective first engine 124, other configurations may be provided as well. For example, referring now to FIG. 13, a top schematic view of a first engine 124 and a first thrust vectoring system 128 in accordance with another exemplary aspect of the present disclosure is provided. The first engine 124 and first thrust vectoring system 128 of FIG. 13 is configured in a similar manner as the exemplary first engine 124 and first thrust vectoring system 128 of FIG. 12.

For example, the first engine 124 includes a turbomachine 202 and fan assembly 204 having a fan 230. The first thrust vectoring system 128, operable with the first engine 124, is depicted in a configuration that combines both vertical airflow fins 1002 and horizontal airflow fins 1104 to provide comprehensive thrust vectoring capabilities in both the horizontal plane and the vertical plane.

However, in the embodiment depicted in FIG. 13, the first engine 124 further includes a nacelle 240 that encloses the fan 230 and defines in part a fan inlet 244, and further defines an engine exhaust 246 for the embodiment shown. The nacelle 240 surrounds the fan 230 and at least a portion of the turbomachine 202. The first thrust vectoring system 128 is positioned upstream of the engine exhaust 246, and, more specifically, is enclosed at least in part in the outer nacelle 240. Such an arrangement may provide a more compact system.

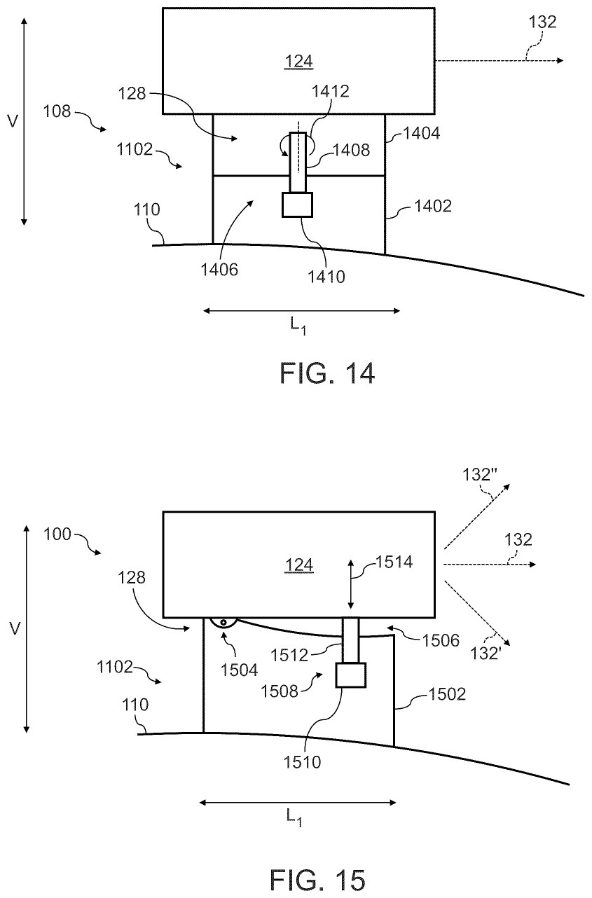

Moreover, although the exemplar first thrust vectoring system 128 described above are operable with the first engine 124 to redirect a thrust-producing airflow from the first engine 124 directly, in other embodiments, other suitable configurations may be provided. For example, referring now to FIG. 14, a side, schematic view of a first engine 124 and first thrust vectoring system 128 in accordance with another exemplary embodiment of the present disclosure is provided. In this embodiment, the first engine 124 is mounted to a body 110 of the aircraft 100 and is operable with the first thrust vectoring system 128, which includes a stationary pylon 1402 and a rotating pylon 1404. The stationary pylon 1402 is fixedly attached to the body 110 and supports the rotating pylon 1404, which is configured to rotate in a rotating direction 1412 using an actuator 1406.

In particular, for the embodiment depicted, the rotating pylon 1404 is coupled to the first engine 124 and is capable of rotating in the rotating direction 1412 relative to the stationary pylon 1404, which allows for an adjustment of the first thrust vector 132 in a horizontal plane. This rotation is facilitated by the actuator 1406 of the first thrust vectoring system 128, which includes a motor 1410 and a shaft 1408 coupled to the rotating pylon 1404. The motor 1410 drives the shaft 1408, which is moveable in the rotating direction 1412 by the motor 1410, to rotate the rotating pylon 1404 in the rotating direction 1412.

The actuator 1406 provides the necessary mechanical force to adjust a position of the first engine 124 and, consequently, a direction of the first thrust vector 132. This capability of the first thrust vectoring system 128 to adjust the first thrust vector 132 in the horizontal plane enhances a maneuverability and control of the aircraft 100, particularly during ground operations or in-flight maneuvers that require changes in the aircraft's direction or attitude.

The embodiment depicted in FIG. 14 is exemplary and demonstrates the flexibility of the present disclosure in adapting the thrust vectoring capabilities to various engine mounting configurations. The rotating pylon 1404 and the associated actuator 1406 represent an innovative approach to thrust vectoring, allowing for the entire engine 124 to be moved in the horizontal plane, and adjusting the first thrust vector 132 without the need for traditional control surfaces.

The present disclosure contemplates various embodiments and configurations for the first thrust vectoring system 128, including different types of actuators, such as hydraulic or electric actuators, and various mounting arrangements for the first engine 124. The materials and construction techniques used for the stationary pylon 1402, rotating pylon 1404, and actuator 1406 can be selected based on factors such as weight, strength, and resistance to the operational stresses encountered during the aircraft's operation.

In operation, the first thrust vectoring system 128 can be controlled by the aircraft's control system, which sends command signals to the actuator 1406 to adjust the position of the rotating pylon 1404 and the first engine 124. These adjustments can be made in real-time, responding to the pilot's inputs or automated flight control algorithms, to achieve the desired aircraft trajectory and attitude.

Referring now to FIG. 15, a side schematic view of a first engine 124 and first thrust vectoring system 128 in accordance with yet another exemplary embodiment of the present disclosure is provided. The first engine 124 and first thrust vectoring system 128 may be configured in a similar manner as the exemplary first engine 124 and first thrust vectoring system 128 of FIG. 14.

For example, the aircraft 100 includes a body 110, to which the first engine 124 is mounted. The first engine 124 is operable with the first thrust vectoring system 128. The first thrust vectoring system 128 includes a pylon 1502 mounting the first engine 124 to the body 110.

However, for the embodiment depicted, the pylon 1502 defines a pivot point 1504 with the first engine 124 pivotally connecting the pylon 1502 to the first engine 124. The pivotal connection at the pivot point 1504 allows for the adjustment of a first thrust vector 132 from the first engine 124 in a vertical plane, as indicated by the dashed lines representing an adjusted first thrust vector 132′.

More specifically, the exemplary first thrust vectoring system 128 of FIG. 15 further includes an actuator 1508 that is operably coupled to the pylon 1504. The actuator 1508 includes a motor 1510 and a shaft 1512, which extends in an extension direction 1514. The motor 1510 drives the shaft 1512, causing the pylon 1502 and the first engine 124 to pivot about the pivot point 1504 in a gap 1506 between the pylon 1502 and the first engine 124. This pivotal movement enables the first thrust vectoring system 128 to adjust the first thrust vector 132 in the vertical direction V, enhancing the control and maneuverability of the aircraft 100 during various flight operations.

The first thrust vectoring system 128, as depicted in FIG. 15, can be actuated to direct the first thrust vector 132 upwards or downwards relative to the body 110 of the aircraft 100. This actuation is facilitated by the actuator 1508, which responds to command data provided by a controller (not shown in FIG. 15) based on, e.g., data indicative of the aircraft's operating condition. The controller can be a standalone system or part of the aircraft's overall control system, and it processes data regarding the aircraft's performance, environmental conditions, and pilot inputs to command the necessary adjustments to the first thrust vectoring system 128.

The embodiment illustrated in FIG. 15 is exemplary and demonstrates the adaptability of the present disclosure to various aircraft configurations and flight conditions. The first thrust vectoring system 128, with its integrated actuator 1508 and pylon 1502, provides a novel approach to adjusting the first thrust vector 132, potentially reducing the need for traditional control surfaces and improving the efficiency of the aircraft's propulsion system.

The present disclosure contemplates various embodiments and configurations for the first thrust vectoring system 128, including different types of actuators and mounting arrangements for the first engine 124. Further, in certain exemplary aspects, the system of FIG. 15 could be combined with the system of, e.g., FIG. 14.

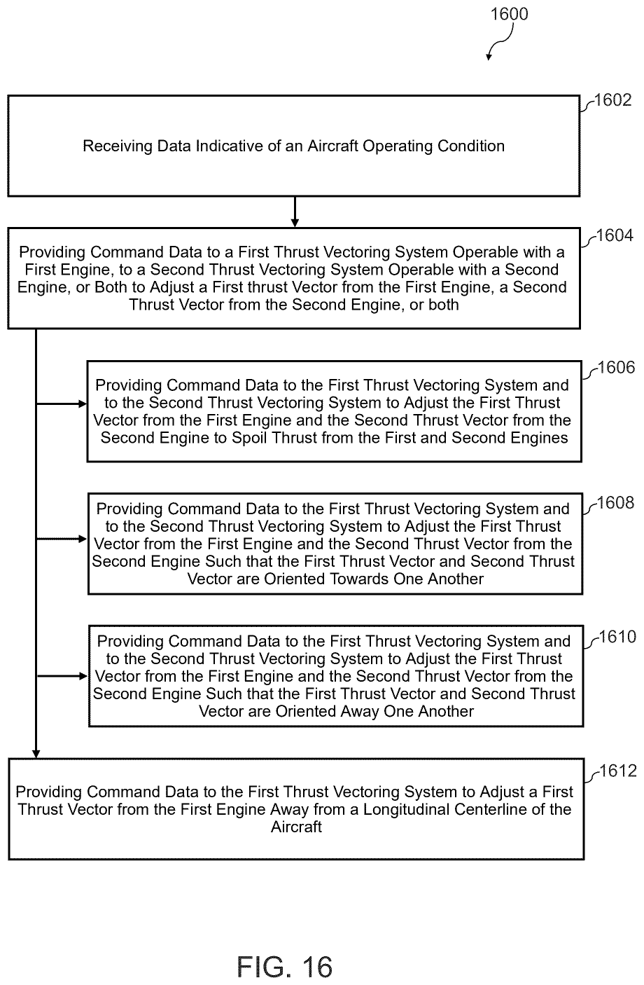

Briefly, referring now to FIG. 16, a method 1600 of operating an aircraft in accordance with an exemplary aspect of the present disclosure is provided. The method 1600 may be utilized with one or more of the exemplary systems described above with reference to FIGS. 1 through 15. Notably, in certain exemplary embodiments, the method 1600 may be carried out at least in part using a controller, such as the controller 500 described above. For example, the controller may include one or more computing devices equipped with one or more processors and a memory. The memory may store data and instructions that, when executed by the processor, cause the controller to perform certain operations, such as the operations of method 1600. The controller may include a network communications module to allow for communication with various sensors, actuator, and potentially other systems within the aircraft to enable the various operations.

The method 1600 includes at (1602) receiving data indicative of an aircraft operating condition; and at (1604) providing command data to a first thrust vectoring system operable with a first engine, to a second thrust vectoring system operable with a second engine, or both to adjust a first thrust vector from the first engine, a second thrust vector from the second engine, or both. The data received at (1602) may include data from sensors indicating engine operating temperatures, engine speeds, engine pressures, altitude, or the like; data from other controllers; and any other data that may be used to determine an aircraft operating condition.

In certain exemplary aspects, the aircraft operating condition is an idle operating condition. With such an exemplary aspect, providing the command data at (1604) includes at (1606) providing command data to the first thrust vectoring system and to the second thrust vectoring system is to adjust the first thrust vector from the first engine and the second thrust vector from the second engine to spoil thrust from the first and second engines. The command data may include control instructions. In particular, providing command data to the first thrust vectoring system and to the second thrust vectoring system at (1606) may include at (1608) providing command data to the first thrust vectoring system and to the second thrust vectoring system to adjust the first thrust vector from the first engine and the second thrust vector from the second engine such that the first thrust vector and second thrust vector are oriented towards one another. Additionally, or alternatively, providing command data to the first thrust vectoring system and to the second thrust vectoring system at (1606) may include at (1610) providing command data to the first thrust vectoring system and to the second thrust vectoring system to adjust the first thrust vector from the first engine and the second thrust vector from the second engine such that the first thrust vector and second thrust vector are oriented away from one another.

Referring still to FIG. 16, in certain exemplary aspects, the aircraft operating condition is a failure condition of the second engine. In such an exemplary aspect, providing the command data at (1604) includes at (1612) providing command data to the first thrust vectoring system to adjust a first thrust vector from the first engine away from a longitudinal centerline of the aircraft.

Incorporation of the first and second thrust vectoring systems with the propulsion system may allow for a reduction in size of one or more control surfaces. Additionally, the first and second thrust vectoring systems further may allow for adjustment for yaw in the event of unbalanced thrust due to an engine failure, allowing the engines to be spaced farther apart along the lateral direction, improving overall aerodynamic efficiency of the aircraft. Moreover, the first and second thrust vectoring systems may allow the aircraft to spoil thrust by directing nozzles towards or away from each other to minimize ground idle thrust and brake wear of the aircraft.

Further aspects are provided by the subject matter of the following clauses:

An aircraft defining a longitudinal direction, a lateral direction, and a longitudinal centerline extending along the longitudinal direction, the aircraft comprising: a body; a pair of wings extending outward from the body along the lateral direction, each wing of the pair of wings defining a leading edge; and a propulsion system comprising a first engine and a second engine spaced from one another along the lateral direction, the propulsion system further comprising a first thrust vectoring system operable with the first engine and a second thrust vectoring system operable with the second engine.

The aircraft of any preceding clause, wherein the aircraft defines a horizontal plane extending in the lateral direction and in the longitudinal direction, wherein the first thrust vectoring system is operable with the first engine to adjust a first thrust vector from the first engine in the horizontal plane, and wherein the second thrust vectoring system is operable with the second engine to adjust a second thrust vector from the second engine in the horizontal plane.

The aircraft of any preceding clause, wherein the first thrust vectoring system is operable with the first engine to further adjust the first thrust vector from the first engine out of the horizontal plane, and wherein the second thrust vectoring system is operable with the second engine to further adjust the second thrust vector from the second engine out of the horizontal plane.

The aircraft of any preceding clause, wherein the first engine defines an engine exhaust, and wherein the first thrust vectoring system is a variable nozzle located at the engine exhaust or downstream of the engine exhaust.

The aircraft of any preceding clause, wherein the first engine defines an axial direction and a circumferential direction, wherein the variable nozzle comprises a plurality of slats arranged along the circumferential direction.

The aircraft of any preceding clause, wherein each slat of the plurality of slats extends between an upstream end and a downstream end, wherein the upstream end of each slat defines a pivot point and is configured to pivot about the pivot point.

The aircraft of any preceding clause, wherein the variable nozzle comprises a plurality of actuators spaced along the circumferential direction, wherein each actuator is operably coupled to at least one slat of the plurality of slats and less than all of the slats of the plurality of slats.

The aircraft of any preceding clause, wherein the plurality of slats includes N number of slats, wherein the plurality of actuators includes at least three actuators and up to N number of actuators.

The aircraft of any preceding clause, wherein the plurality of actuators are operable independently of one another.

The aircraft of any preceding clause, wherein the first thrust vectoring system is operable independently of the second thrust vectoring system.

The aircraft of any preceding clause, further comprising: a controller operably coupled to the first thrust vectoring system and the second thrust vectoring system, wherein the controller is configured to receive data indicative of an aircraft operating condition and, in response to receiving the data, provide command data to the first thrust vectoring system and the second thrust vectoring system to adjust a first thrust vector from the first engine and a second thrust vector from the second engine.

The aircraft of any preceding clause, wherein the aircraft operating condition is an idle operating condition, and wherein the command data is to adjust the first thrust vector from the first engine and the second thrust vector from the second engine to spoil thrust from the first and second engines.

The aircraft of any preceding clause, wherein the aircraft operating condition is a course change condition, and wherein the command data is to adjust the first thrust vector from the first engine and the second thrust vector from the second engine to assist is effectuating the course change condition.

The aircraft of any preceding clause, wherein the first engine defines a longitudinal axis spaced from the longitudinal centerline of the aircraft along the lateral direction, and wherein the aircraft further comprises: a controller operably coupled to the first thrust vectoring, wherein the controller is configured to receive data indicative of a failure condition of the second engine and, in response to receiving the data, provide command data to the first thrust vectoring system to adjust a first thrust vector from the first engine away from the longitudinal centerline of the aircraft.

The aircraft of any preceding clause, further comprising: a mounting assembly, wherein the first engine is mounted to the body through the mounting assembly, and wherein the first thrust vectoring system is integrated into the mounting assembly.

The aircraft of any preceding clause, wherein the mounting assembly comprises a pylon.

The aircraft of any preceding clause, wherein the first engine defines an engine exhaust, and wherein the first thrust vectoring system comprises a plurality of control surfaces located at the engine exhaust or downstream of the engine exhaust.

The aircraft of any preceding clause, wherein the plurality of control surfaces comprises a plurality of airflow fins, wherein each fin of the plurality of airflow fins defines a pivot axis oriented in a vertical direction.

The aircraft of any preceding clause, wherein the plurality of airflow fins is a first plurality of airflow fins, wherein the plurality of control surfaces further comprises a second plurality of airflow fins, wherein each fin of the second plurality of airflow fins defines a pivot axis oriented in the lateral direction.

The aircraft of any preceding clause, wherein the fins of the first plurality of airflow fins or second plurality of airflow fins define cutouts, and wherein the fins of the other of the first plurality of airflow fins or second plurality of airflow fins are positioned within the cutouts.

The aircraft of any preceding clause, wherein the plurality of control surfaces comprises a plurality of airflow fins, wherein each fin of the plurality of airflow fins defines a pivot axis oriented in the lateral direction.

The aircraft of any preceding clause, wherein the first engine is arranged in a pusher configuration.

The aircraft of any preceding clause, wherein the first engine comprises a fan nozzle defining the engine exhaust, and wherein the plurality of control surfaces are located at least partially within the fan nozzle or downstream of the fan nozzle.

The aircraft of any preceding clause, wherein the aircraft is a blended wing aircraft, wherein during a cruise operating condition of the aircraft, the body contributes between 10% and 95% of an upward lift for the aircraft.

The aircraft of any preceding clause, wherein the first engine comprises a fan, a turbomachine driving the fan, and an outer nacelle surrounding the fan and the turbomachine at least in part.

The aircraft of any preceding clause, wherein the turbomachine is located outside the body of the aircraft.

The aircraft of any preceding clause, wherein the first engine is a mixed flow engine.

A method of operating an aircraft, the method comprising: receiving data indicative of an aircraft operating condition; and providing command data to a first thrust vectoring system operable with a first engine, to a second thrust vectoring system operable with a second engine, or both to adjust a first thrust vector from the first engine, a second thrust vector from the second engine, or both.

The method of any preceding clause, wherein the aircraft operating condition is an idle operating condition, and wherein providing the command data comprises providing command data to the first thrust vectoring system and to the second thrust vectoring system is to adjust the first thrust vector from the first engine and the second thrust vector from the second engine to spoil thrust from the first and second engines.

The method of any preceding clause, wherein providing command data to the first thrust vectoring system and to the second thrust vectoring system comprises providing command data to the first thrust vectoring system and to the second thrust vectoring system to adjust the first thrust vector from the first engine and the second thrust vector from the second engine such that the first thrust vector and second thrust vector are oriented towards one another.

The method of any preceding clause, wherein providing command data to the first thrust vectoring system and to the second thrust vectoring system comprises providing command data to the first thrust vectoring system and to the second thrust vectoring system to adjust the first thrust vector from the first engine and the second thrust vector from the second engine such that the first thrust vector and second thrust vector are oriented away from one another.

The method of any preceding clause, wherein the aircraft operating condition is a failure condition of the second engine, and wherein providing the command data comprises providing command data to the first thrust vectoring system to adjust a first thrust vector from the first engine away from a longitudinal centerline of the aircraft.

A controller comprising one or more processors and a memory, the memory storing data and instructions that, when executed by the processor, cause the controller to perform operations, the operations being the steps of a method of any preceding clause.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. An aircraft defining a longitudinal direction, a lateral direction, and a longitudinal centerline extending along the longitudinal direction, the aircraft comprising:
a body;
a pair of wings extending outward from the body along the lateral direction, each wing of the pair of wings defining a leading edge; and
a propulsion system comprising a first engine and a second engine spaced from one another along the lateral direction, the propulsion system further comprising a first thrust vectoring system operable with the first engine and a second thrust vectoring system operable with the second engine.

2. The aircraft of claim 1, wherein the aircraft defines a horizontal plane extending in the lateral direction and in the longitudinal direction, wherein the first thrust vectoring system is operable with the first engine to adjust a first thrust vector from the first engine in the horizontal plane, and wherein the second thrust vectoring system is operable with the second engine to adjust a second thrust vector from the second engine in the horizontal plane.

3. The aircraft of claim 2, wherein the first thrust vectoring system is operable with the first engine to further adjust the first thrust vector from the first engine out of the horizontal plane, and wherein the second thrust vectoring system is operable with the second engine to further adjust the second thrust vector from the second engine out of the horizontal plane.

4. The aircraft of claim 1, wherein the first engine defines an engine exhaust, and wherein the first thrust vectoring system is a variable nozzle located at the engine exhaust or downstream of the engine exhaust.

5. The aircraft of claim 4, wherein the first engine defines an axial direction and a circumferential direction, wherein the variable nozzle comprises a plurality of slats arranged along the circumferential direction.

6. The aircraft of claim 5, wherein each slat of the plurality of slats extends between an upstream end and a downstream end, wherein the upstream end of each slat defines a pivot point and is configured to pivot about the pivot point.

7. The aircraft of claim 5, wherein the variable nozzle comprises a plurality of actuators spaced along the circumferential direction, wherein each actuator is operably coupled to at least one slat of the plurality of slats and less than all of the slats of the plurality of slats.

8. The aircraft of claim 7, wherein the plurality of slats includes N number of slats, wherein the plurality of actuators includes at least three actuators and up to N number of actuators.

9. The aircraft of claim 7, wherein the plurality of actuators are operable independently of one another.

10. The aircraft of claim 1, wherein the first thrust vectoring system is operable independently of the second thrust vectoring system.

11. The aircraft of claim 1, further comprising:
a controller operably coupled to the first thrust vectoring system and the second thrust vectoring system, wherein the controller is configured to receive data indicative of an aircraft operating condition and, in response to receiving the data, provide command data to the first thrust vectoring system and the second thrust vectoring system to adjust a first thrust vector from the first engine and a second thrust vector from the second engine.

12. The aircraft of claim 11, wherein the aircraft operating condition is an idle operating condition, and wherein the command data is to adjust the first thrust vector from the first engine and the second thrust vector from the second engine to spoil thrust from the first and second engines.

13. The aircraft of claim 11, wherein the aircraft operating condition is a course change condition, and wherein the command data is to adjust the first thrust vector from the first engine and the second thrust vector from the second engine to assist is effectuating the course change condition.

14. The aircraft of claim 1, wherein the first engine defines an engine exhaust, and wherein the first thrust vectoring system comprises a plurality of control surfaces located at the engine exhaust or downstream of the engine exhaust.

15. The aircraft of claim 14, wherein the plurality of control surfaces comprises a plurality of airflow fins, wherein each fin of the plurality of airflow fins defines a pivot axis oriented in a vertical direction.

16. The aircraft of claim 15, wherein the plurality of airflow fins is a first plurality of airflow fins, wherein the plurality of control surfaces further comprises a second plurality of airflow fins, wherein each airflow fin of the second plurality of airflow fins defines a pivot axis oriented in the lateral direction.

17. The aircraft of claim 16, wherein the airflow fins of one of i) the first plurality of airflow fins or ii) the second plurality of airflow fins define cutouts, and wherein the airflow fins of the other of i) the first plurality of airflow fins or ii) the second plurality of airflow fins are positioned within the cutouts.

18. The aircraft of claim 14, wherein the first engine is arranged in a pusher configuration.

19. The aircraft of claim 1, wherein the aircraft is a blended wing aircraft, wherein during a cruise operating condition of the aircraft, the body contributes between 10% and 95% of an upward lift for the aircraft.

20. A method of operating an aircraft, the method comprising:
receiving data indicative of an aircraft operating condition; and
providing command data to a first thrust vectoring system operable with a first engine, to a second thrust vectoring system operable with a second engine, or both to adjust a first thrust vector from the first engine, a second thrust vector from the second engine, or both.
